(19) United States
(12) Patent Application Publication
(10) Pub. No.: US 2015/0034856 A1
(43) Pub. Date: Feb. 5, 2015

(54) NANOPARTICLE, PERMANENT MAGNET, MOTOR, AND GENERATOR

(71) Applicant: SIEMENS AKTIENGESELLSCHAFT, München (DE)

(72) Inventor: Gotthard Rieger, Munich (DE)

(73) Assignee: SIEMENS AKTIENGESELLSCHAFT, München (DE)

(21) Appl. No.: 14/383,454

(22) PCT Filed: Feb. 11, 2013
(86) PCT No.: PCT/EP2013/052659

§ 371 Date: Sep. 5, 2014

(30) Foreign Application Priority Data
Mar. 15, 2012 (DE) 102012204083.8

(51) Int. Cl. H01F 1/03

(52) U.S. Cl. CPC H01F 1/0302
USPC 252/62.55; 252/62.51 R

(57) ABSTRACT

At least one elongated core, made of at least one first magnetizable and/or magnetic material, and a shell, surrounding the core and made of at least one second magnetocrystalline anisotropic material, form a nanoparticle. A plurality of such nanoparticles are used in making a permanent magnet. A motor or a generator includes at least one such permanent magnet.

### CROSS REFERENCE TO RELATED APPLICATIONS

This application is the U.S. national stage of International Application No. PCT/EP2013/052659, filed Feb. 11, 2013 and claims the benefit thereof. The International Application claims the benefit of German Application No. 102012204083.8 filed on Mar. 15, 2012, both applications are incorporated by reference herein in their entirety.

### BACKGROUND

Described below are a nanoparticle, a permanent magnet and also a motor and a generator.

The search for new permanently magnetic materials has undergone a strong revival owing to nanotechnology. This is because permanently magnetic properties, in addition to the high magnetization (magnetic polarization), depend to a large extent on magnetization processes on a mesoscopic scale, on account of a suitable atomic and crystallographic structure. Permanent magnet properties are promoted by the microstructural configuration as nano-scale single-domain particles, as predicted in theory and as is known from experimentation through the microstructure formation when using the rapid solidification technique.

The synthetic structure of permanently magnetic materials made up of nanoparticles with high spontaneous magnetization is, however, hindered by the increasing oxidation sensitivity in nanoparticles. Furthermore, the coercive field strengths which can be achieved by what is termed shape anisotropy cannot be achieved by experimentation.

Whereas a coercive field strength which is sufficiently high for almost all present-day applications is produced in current permanent magnets based on rare earth elements (e.g. SmCo or NdFeB) through a high magnetocrystalline anisotropy in microcrystalline microstructures produced by metallurgical processes, the remanent magnetization in these systems remains limited to the spontaneous magnetization of the magnetically hard phase (e.g. Nd₂Fe₁₄B of 1.61 T).

Ensembles of oriented single-domain nanoparticles can be produced by nanotechnological synthesis processes on account of the possibility of shaping. The anisotropy field based on the shape effect (as an upper limit for the coercive field) is, however, limited in this case.

This is because, on account of influences from the ensemble but also on account of the fact that the coercive field is reduced by defects at the surface and also corners and edges, it has not been clear to date whether the anisotropy in the ensemble of nanoparticles can be increased, and whether additionally other magnetic reversal modes (curling, fanning) emerge that likewise result in a reduced coercive field.

### SUMMARY

It is therefore possible to provide an improved nanoparticle which makes it possible to overcome the aforementioned disadvantages of the related art. In particular, the nanoparticle makes it possible to provide an improved permanently magnetic material. An improved permanent magnet and also an improved motor and an improved generator can be provided using such nanoparticles.

The nanoparticle includes at least an elongated core, which is formed with at least a first, magnetizable and/or magnetized, material.

In this case, the nanoparticle may be understood as a particle with a cross-sectional diameter of less than 1000 nm. In particular, the nanoparticle may have a cross-sectional diameter of less than 300 nm.

Hereinbelow, an elongated core is to be understood as meaning a core with an aspect ratio, that is the ratio between longitudinal and transverse dimension, of at least 1.5. It is suitable for the aspect ratio to be at least 5, ideally at least 10.

The nanoparticle additionally includes a shell, which surrounds the core and which is formed with at least a second material having magnetocrystalline anisotropy. It is expedient that the second material of the shell adjoins the first material of the core with an interface.

The nanoparticle consequently has what is termed a core-shell structure, this involving at least two materials which advantageously lead to a high permanently magnetic performance, specifically a high remanence, a high coercive field and a high energy product as well as high long-term stability. The core with the first material has a high level of magnetization and/or magnetizability, the second material of the shell having a high level of magnetocrystalline anisotropy. This magnetocrystalline anisotropy stabilizes the surface of the core, in particular the interface which is expediently present between the core and the shell, and prevents magnetic reversal as a result of defects at this surface or interface. Moreover, the selection of the first and second material achieves magnetic exchange coupling, which leads to a single-phase magnetic reversal behavior and therefore promotes homogeneous rotation with high coercive fields. In this case, it is possible for the energy density to be at least doubled compared to the prior art. With the nanoparticle described below, it is therefore possible to provide an ensemble which is suitable for building up an improved permanent magnet.

It is desirable in the case of the nanoparticle that the first material, at least as volume material, is magnetically soft. Advantageously, on account of the shape anisotropy, materials known as magnetically soft metals and alloys, such as in particular ferromagnetic materials such as NiFe or CoFe, acquire as volume material permanently magnetic properties with considerable magnetic reversal stability.

In a development, in the nanoparticle the first material is formed with ferromagnetic material, in particular Fe. It is suitable in this case that the ferromagnetic material is formed from or with an alloy and/or a solid solution with Fe, in particular NiFe or CoFe. Expediently, the first material may include one or more transition metals or FeCo, in particular with a high Fe content.

It is expedient in the case of the nanoparticle that the second material is magnetically hard.

It is desirable in the case of the nanoparticle that the second material is formed from or with MnBi and/or MnAlC and/or FePt. In particular, in the latter case the second material is formed by deposition of Pt on Fe and subsequent heating.

As an alternative or in addition, the second material is formed from or with CoPt, FePt, FePd, magnetically hard rare earth compounds such as SmCo and NdFeB or from/with hard ferrites such as SrBa ferrites. It is desirable in this case that the first material is formed from or with FeCo.

In a development, the nanoparticle and/or the core of the nanoparticle is in the form of a nanorod and/or nanowire, expediently in the form of an elongated ellipsoid.

It is suitable in the case of the nanoparticle that at least half the volumetric proportion of the nanoparticle, such as more than 90% of the volumetric proportion, is apportioned to the core. Advantageously, it is thereby possible to achieve a particularly high level of permanent magnetization of the nanoparticle and therefore also a high level of permanent magnetization of an ensemble of nanoparticles in relation to the space occupied by the nanoparticle. It is expedient in this case that the second material is formed as/with self assembly monolayers (SAM). It is advantageous that the exchange interaction between the second material of the shell and the first material of the core is independent of the thickness of the shell. Consequently, it is possible to achieve good stabilization of the magnetization of the core even by a single cohesive monolayer as the shell.

In an advantageous development, the nanoparticle has an outer protective layer designed to protect against corrosion, in particular oxidation. This avoids corrosion, in particular oxidation, of the core of the nanoparticle. It is expedient in the case of the nanoparticle that the protective layer is formed as/with self assembly monolayers (SAM). The protective layer may be formed with FePt and/or MnAlC.

It is particularly desirable in the case of the nanoparticle that the shell in this respect forms the protective layer or at least part of the protective layer. It is ideal in this case that FePt and/or MnAlC is selected for the shell. In the case of FePt, the shell is advantageously produced by the deposition of Pt on Fe and subsequent heat treatment in the interface.

As an alternative and in a similar manner, the protective layer is arranged as a further layer on the shell. The protective layer may be applied as/by self assembly monolayers (SAM).

In the case of the nanoparticle the protective layer may cover the outer surface of the shell over its entire extent and may cover its entire area. This effectively stabilizes the magnetization of the core.

It is advantageous in the case of the nanoparticle that the protective layer is formed with FePt, in particular by deposition of Pt on Fe and subsequent heating.

The permanent magnet includes a plurality of nanoparticles as described above. These permanent magnets can advantageously be used in high-efficiency drives and generators, for instance in stators and rotors of drives and generators.

In an advantageous development of the permanent magnet, the nanoparticles are arranged in such a manner that the orientations of longest dimensions of the nanoparticles have a preferential direction. In particular, the nanoparticles are oriented virtually unidirectionally and/or in parallel in terms of their longest dimensions, i.e. at least half, or even at least 90%, of the nanoparticles scarcely deviate in their orientation, i.e. in particular by at most 20 degrees, from the preferential direction.

The motor described below has a permanent magnet as described above.

The generator described below has a permanent magnet as described above.

It is expedient in the case of the motor or the generator that at least one rotor and/or at least one stator as known per se is present and is formed with one or more permanent magnets as explained above.

### BRIEF DESCRIPTION OF THE DRAWINGS

These and other aspects and advantages will become more apparent and more readily appreciated from the following description of an exemplary embodiment, taken in conjunction with the accompanying drawings of which:

FIG. 1 is a longitudinal section of a nanoparticle in a basic sketch,

FIG. 2 is a schematic block diagram of a permanent magnet, and

FIG. 3 is a schematic block diagram of a generator.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

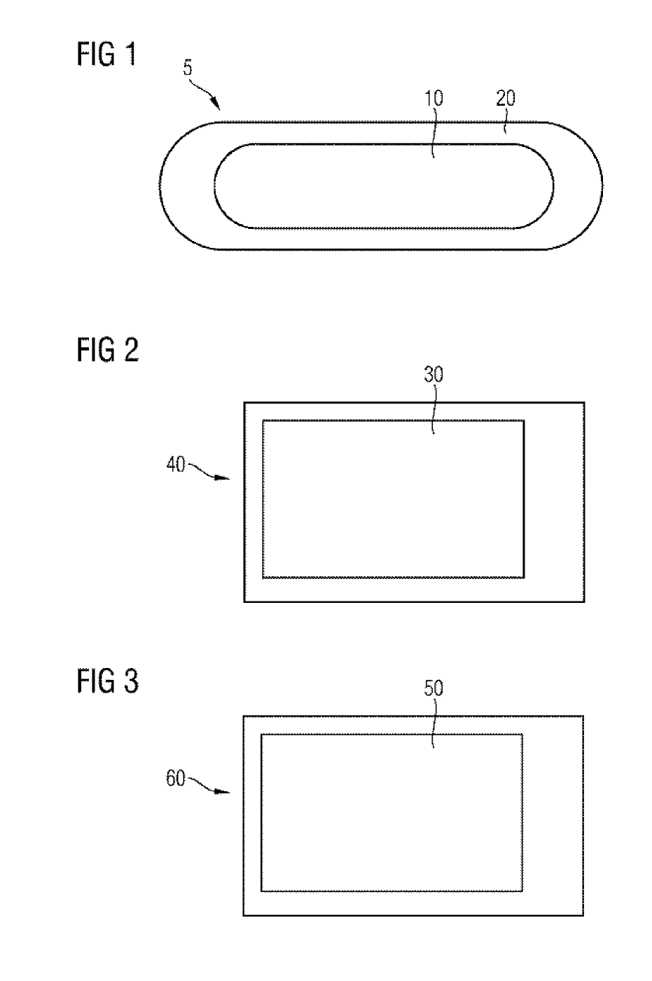

The nanorod 5 which is shown in FIG. 1 has an elongated core 10 made of FeCo. The core 10 has an aspect ratio (ratio between longitudinal dimension and transverse dimension) of approximately 5 (in exemplary embodiments which are not specifically shown and otherwise correspond to that described here, the aspect ratio is 10). Virtually the entire volumetric proportion, here 90% of the volumetric proportion, of the nanorod 5 is apportioned to the core 10. The core bears a high level of magnetization.

The nanorod 5 moreover has a shell made of material having magnetocrystalline anisotropy, in the exemplary embodiment shown FePt. The magnetocrystalline anisotropy of the shell 20 stabilizes the surface of the core 10 and prevents magnetic reversal at the surface of the core 10 as a result of defects.

Between the materials of the core 10 and the shell 20, there is a magnetic exchange coupling, this leading to a single-phase magnetic reversal behavior of the nanorod 5 and consequently to homogeneous rotation with high coercive fields.

On account of its suitable corrosion properties, the shell 20 when formed from FePt simultaneously acts as a protective layer. This protective layer protects the core 10 from oxidation. The shell 20 of the nanorod 5 is in this case produced by the deposition of Pt on Fe and final heat treatment of the interface.

However, the shell 20 can also be formed as a thin layer, i.e. a layer between one and five monolayers thick, for example by self assembly monolayers (SAM).

In an alternative exemplary embodiment, which otherwise corresponds to the exemplary embodiment described above, a protective layer formed by self assembly monolayers (SAM) made of MnAlC is additionally applied to the shell 20.

In further exemplary embodiments which are not specifically shown, the nanorod corresponds to the nanorod 5 described above, but the core as a variation does not consist of FeCo but rather of a different magnetically soft material.

Further exemplary embodiments of nanorods which are not specifically depicted correspond to the nanorods described in the exemplary embodiments above, but in these exemplary embodiments the shell as a variation does not consist of FePt but rather of CoPt, FePd, MnAlC or magnetically hard rare earth compounds such as SmCo or NdFeB or hard ferrites such as SrBa ferrites. In the case of MnAlC, the shell likewise simultaneously acts as an anti-corrosion protective layer for the nanorod.

An ensemble 30 of nanorods as described above, for example an ensemble 30 of the nanorods 5, is part of the permanent magnet 40 as shown in FIG. 2.

In this case, the nanorods 5 of the ensemble 30 have a preferential direction. In the exemplary embodiment shown, the nanorods 5 are oriented parallel to one another. For the purposes of the parallel orientation, the nanorods 5 of the ensemble 30 are located in a matrix, for example made of aluminum (not shown in detail). A surface of the matrix has a plurality of pores, these forming openings of nanoscopic blind holes extending parallel to one another into the matrix. The nanorods 5 are located in these blind holes extending parallel to one another, the longest dimensions of the nanorods extending along the direction of extent of the blind holes. Consequently, the nanorods 5 are oriented parallel to one another in accordance with the mutually parallel orientation of the blind holes. By way of example, nanorods oriented in this way can be produced in the manner described by Narayanan et al. (Nanoscale Res. Lett. 2010 5, 164-168, in particular FIG. 1 and associated text).

As a consequence of the parallel orientation of the nanorods, the permanent magnetic fields of the individual nanorods combine to give a correspondingly enlarged total field of the ensemble of nanorods, and therefore the permanent magnet 40 realized in this way has a sufficiently large permanently magnetic field.

The generator 60 as shown in FIG. 3 has, in a manner known per se, a rotor-stator assembly 50 formed by permanent magnets 40. In contrast to the related art, in this case the permanent magnets of the rotor-stator assembly 50 are formed with permanent magnets 40.

In an exemplary embodiment which is not specifically shown, the rotor-stator assembly 50 is a component part of a motor.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-15. (canceled)

16. A nanoparticle comprising:
an elongated core, formed of a first material at least one of a magnetizable and magnetized; and
a shell, surrounding the elongated core, formed of at least a second material having magnetocrystalline anisotropy.

17. The nanoparticle as claimed in claim 16, wherein the first material, at least as volume material, is magnetically soft.

18. The nanoparticle as claimed in claim 16, wherein the first material includes ferromagnetic material, in particular Fe, preferably with an alloy and/or a solid solution with Fe, in particular NiFe or CoFe.

19. The nanoparticle as claimed in claim 18, wherein the first material includes iron.

20. The nanoparticle as claimed in claim 19, wherein the first material includes at least one of an iron alloy and a solid solution containing iron.

21. The nanoparticle as claimed in claim 20, wherein the first material includes at least one of NiFe and CoFe.

22. The nanoparticle as claimed in claim 16, wherein the second material is magnetically hard.

23. The nanoparticle as claimed in claim 16, wherein the second material is formed with a material having magnetocrystalline anisotropy, preferably MnBi and/or MnAlC and/or FePt, in particular by means of the deposition of Pt on Fe and subsequent heating.

24. The nanoparticle as claimed in claim 16, formed as one of a nanorod and nanowire.

25. The nanoparticle as claimed in claim 16, wherein at least half the volumetric proportion of the nanoparticle is apportioned to the core.

26. The nanoparticle as claimed in claim 16, wherein the shell forms at least part of an outer protective layer protecting against corrosion, including oxidation.

27. The nanoparticle as claimed in claim 16, further comprising an outer protective layer protecting against corrosion, including oxidation.

28. The nanoparticle as claimed in claim 27, wherein the outer protective layer covers the outer surface of the shell.

29. The nanoparticle as claimed in claim 27, wherein the protective layer is formed of self assembly monolayers.

30. The nanoparticle as claimed in claim 27, wherein the protective layer is formed of FePt.

31. A permanent magnet comprising:
a plurality of nanoparticles, each including
an elongated core, formed of a first material at least one of a magnetizable and magnetized; and
a shell, surrounding the elongated core, formed of at least a second material having magnetocrystalline anisotropy.

32. The permanent magnet as claimed in claim 31, wherein the nanoparticles have a longest dimensions with a preferential direction.

33. A motor, comprising:
at least one permanent magnet including a plurality of nanoparticles, each nanoparticle including
an elongated core, formed of a first material at least one of a magnetizable and magnetized; and
a shell, surrounding the elongated core, formed of at least a second material having magnetocrystalline anisotropy.

34. A generator, comprising:
at least one permanent magnet including a plurality of nanoparticles, each nanoparticle including
an elongated core, formed of a first material at least one of a magnetizable and magnetized; and
a shell, surrounding the elongated core, formed of at least a second material having magnetocrystalline anisotropy.
